(19) United States
(12) Patent Application Publication
(10) Pub. No.: US 2020/0208596 A1
(43) Pub. Date: Jul. 2, 2020

(54) HIGH PRESSURE FUEL PUMP

(71) Applicant: DELPHI TECHNOLOGIES IP LIMITED, ST. MICHAEL (BB)

(72) Inventor: PETER A. COLLINGBORN, GILLINGHAM, KENT (GB)

(21) Appl. No.: 16/631,272

(22) PCT Filed: Jul. 9, 2018
(86) PCT No.: PCT/EP2018/068581

§ 371 Date: Jan. 15, 2020

(30) Foreign Application Priority Data
Jul. 17, 2017 (GB) 1711457.0

(51) Int. Cl. F02M 59/44; F04B 53/16

(52) U.S. Cl. CPC F02M 59/44; F02M 63/0225; F04B 53/16

(57) ABSTRACT

A body of a high pressure fuel pump is provided with a pumping bore extending along a pumping axis, a cylindrical inlet chamber extending in continuation to the pumping bore, and a fuel inlet channel extending along a second axis making an angle with the pumping axis from an inner opening in the inlet chamber to an outer opening. A debris trap is dug in the outer face.

### CROSS REFERENCE TO RELATED APPLICATIONS

This application is a national stage application under 35 USC 371 of PCT Application No. PCT/EP2018/068581 having an international filing date of Jul. 9, 2018, which is designated in the United States and which claimed the benefit of GB Patent Application No. 1711457.0 filed on Jul. 17, 2017, the entire disclosures of each are hereby incorporated by reference in their entirety.

### TECHNICAL FIELD

The present invention relates to a diesel fuel high pressure pump and, more particularly to the body of the pump wherein is arranged a particle trap.

### BACKGROUND OF THE INVENTION

A diesel internal combustion engine fueled with a direct injection equipment is provided with a high pressure pump that receives from a low pressure tank an upstream fuel flow and, that delivers to a common rail and to fuel injectors a downstream high pressure fuel flow compressed to several thousands of bars.

In said pump fuel flowing in an inlet channel enters a compression chamber via an inlet opening controlled by an inlet valve member. Said valve member defines a closing face that cooperates with a seating face defined on the body of the pump and, when the inlet valve member is moved in a closed position, the closing face comes in sealing contact against the seating face, enabling pressure to rise in the compression chamber.

It is of utmost importance to protect said pump and all downstream components from particles present in the fuel and that may cause damages. In particular any particle trapped between the closing face and the seating face prevents full closing of the valve member and enables a back flow from the compression chamber to the inlet channel, decreasing the downstream high pressure fuel flow.

In particular, when the engine is being cranked, turned over by the starter motor, before the first firing after being assembled, the rotational speed of the pump is correspondingly very low. Ample filling pressure is applied to the fuel from an external source, but that cannot make the fuel flow rate be bigger than what the movement of the pumping plunger allows. Therefore, the fuel's flow rate is very small, and only a tiny displacement of the inlet valve is necessary to allow that rate. Any debris which had settled, by gravity, around the valve seat, while the pump is at rest, after testing in the factory, could be carried into the small gap at the inlet valve seat, and caught there. After the filling period, the plunger starts to rise and to compress the fuel in the pumping chamber. The pressure in the fuel rises, so the load acting to close the inlet valve increases, and the valve tries to close. It is prevented from reaching its seat in the hydraulic head by the debris. The plunger forces the fuel back into the filling circuit, through the small annular gap at the seat. Even though the pressure in the pumping chamber, which is required to expel the fuel, may be many times greater than the supplied filling pressure, it remains too low to permit injection of fuel into the engine cylinder, and the engine does not start.

### SUMMARY OF THE INVENTION

Accordingly, it is an object of the present invention to resolve the above mentioned problems in providing a body of a high pressure fuel pump adapted to be arranged in a diesel fuel injection equipment of an internal combustion engine, said body having an outer face and being provided with a pumping bore extending along a pumping axis and defining in part a compression chamber, a cylindrical inlet chamber extending in continuation to the pumping bore defining an inlet opening in said compression chamber, a fuel inlet channel extending along a second axis making an angle with the pumping axis, said channel extending from an inner opening in said inlet chamber to an outer opening, fuel at low pressure flowing, in use, in said channel and, a debris trap dug in said outer face and defining a bottom face and a lateral face, the inlet channel outer end opening in said lateral face.

Said debris trap is cylindrical and it extends from said outer face to said bottom face along a third axis substantially parallel to the pumping axis.

The inlet channel outer opening may be adjacent to the outer face, the debris trap extending deeper than said inlet channel opening, the bottom face defining a blind end that is at a distance from said inlet channel opening.

The depth (P36) of the debris trap may be defined as:

P36>k1·H32 where k1 is a coefficient and,

H32=D30/sin(A) and, 1.0<k1 and where,

P36 is the depth of the recess;

H32 is the opening height of the inlet channel in the lateral face of the trap;

D30 is the diameter of the fuel inlet channel;

A is the angle between the pumping axis and the second axis.

The diameter of the debris trap may be bigger than the diameter of the inlet channel.

Also, the diameter D36 of the debris trap is defined as:

D36>k2·D30 and 1.5<k2 and wherein

The invention further extends to a high pressure pump adapted to be arranged in a diesel fuel injection equipment of an internal combustion engine, said high pressure pump having a body as claimed in any one of the preceding claims and wherein, a piston is slidably guided in the pumping bore and, an inlet valve member controls the inlet opening in the compression chamber.

### BRIEF DESCRIPTION OF THE DRAWINGS

The present invention is now described by way of example with reference to the accompanying drawings in which:

FIG. 1 is a section of a body of a diesel high pressure pump.

### DESCRIPTION OF THE PREFERRED EMBODIMENTS

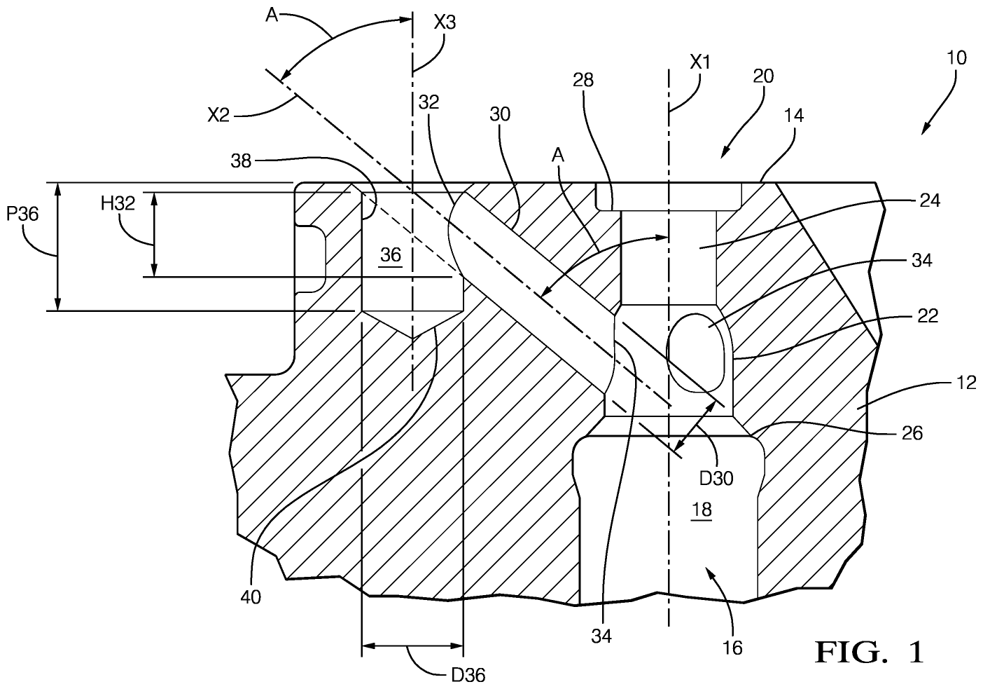

The present invention is now described by way of example with reference to the accompanying FIG. 1 that is a section of the body 12 of a diesel high pressure pump 10.

Said high pressure pump 10, that is part to a direct injection equipment fueling a diesel internal combustion engine, comprises a pumping head having said body 12 provided with a through drilling extending along a pumping axis X1 from an lower opening, not shown, to a top opening in an outer face 14 of the body.

The lower portion of said through drilling forms a pumping bore 16 extending from said lower opening to a compression chamber 18 and, the upper portion of said drilling is an inlet valve bore 20 upwardly extending from the compression chamber 18 to said top opening, said inlet valve bore 20 comprising a lower portion forming a cylindrical inlet chamber 22 arranged in vicinity to the compression chamber 18 and, an upper portion forming a valve guiding bore 24. As visible on the figure, the pumping bore 16 has the largest cross-section and it restricts defining a closed annular seating face 26 separating the compression chamber 18 from said inlet chamber 22. The upper valve guiding bore 24 has the smallest cross-section directly opening in said outer face 14 or, as shown, in the bottom of a shallow recess dug in said outer face and forming a spring seating face 28.

Also, the body 12, is provided with inlet channels 30 drilled along a second axis X2 angled relative to the pumping axis X1 and extending from an outer end 32 to an inner opening 34 opening in the lateral face of said inlet chamber 22. The two-dimension section of the view enables representation of only one complete inlet channel 30, while the pump embodiment described has three inlet channels 30, the opening 34 of a second channel in said inlet chamber being visible. Alternatively, other pumps may be provided with only one, two or more than three channels. Also, in the example the angle A between the pumping axis X1 and the second axis X2 is about 45° while other angular values can be chosen.

Furthermore, the body 12 is provided with a debris trap 36 arranged at the outer end 32 of the inlet channel, said debris trap 36 being dug in the outer face 14 coincident with the outer end 30 of the inlet channel. Said debris trap 36 extends along a third axis X3 parallel to the pumping axis X1 and it defines a lateral face 38, in which opens the inlet channel outer end 32, and a bottom face 40. The debris trap 36 is identified by its function and it can take the form of a blind hole having a conical bottom face 40, as it is shown on the figure, or a recess having a flat bottom. The depth P36 of said blind hole 36 axially X3 extends beyond the opening 32 of the inlet channel in the lateral face 38 and, considering the inlet channel 30 having a circular cross-section of diameter D30, said opening 32 in the lateral face 38 axially X3 extends over an opening height H32 calculated as:

H32=D30/sin(A)

The debris trap 36 is represented cylindrical but other shapes are acceptable.

In the case of a flat bottom face 40 the depth P36 of the debris trap 36 is measured between the outer face 14 and said flat bottom face 40 and, in the embodiment presented where said bottom face 40 is conical, the depth P36 is the axial length of the lateral side 38.

The depth P36 extends beyond said opening height H32 and can be calculated as:

P36>k1·H32 where 1.0<k1

Furthermore, the cross section of the debris trap 36 is much larger than the cross-section of the inlet channel. In the shown example, the blind hole 36 has a circular cross-section of diameter D36 ranging as follow:

1.5D30<D36<3.0D30

As represented by the dotted line continuing the inlet channel 30 beyond the outer end 32, said blind hole 36 is large enough to enable manufacturing of the inlet channel 30, the drilling tool being able to engage the body and to extend outside.

Of course, each of the inlet channels 30 is provided with a debris trap 36, only one being described here, the others not shown on the 2D figure, being similar.

As the person skilled in the art of high pressure diesel pumps knows, when assembled the pump 10 comprises a piston slidably guided in the pumping bore 16 and an inlet valve member having a stem slidably guided in the valve guiding bore 24 and a head protruding in the compression chamber 18 and defining a closing face arranged to cooperate with the seating face 26.

In use, the piston reciprocally moves in the pumping bore 16 varying the volume of the compression chamber 18 and, the inlet valve member also moves alternatively to open or close a fluid passage from the inlet chamber 22 to the compression chamber 18, enabling fuel inlet into, or preventing fuel egress from, the compression chamber. Thanks to the debris trap 36, the entry opening of the inlet channel 30 is perpendicular to the outer face 14, and, considering that generally the pump 10 is arranged so the pumping axis X1 is substantially vertical, debris falling from the outside go down the bottom end of the trap 36 and do not enter the inlet channel 30.

Said trap 36 being deeper than the inlet channel entry, the debris trapped therein collect by the bottom face 40. At low engine RPM, the linear speed of the fuel flow being very low in the trap 36, as the fuel approaches the inlet channel 30 the natural flow path of the fuel is well separated from where the debris collect. These two aspects, depth and large cross section, help to ensure that the debris is collects and remains in the bottom of the debris trap.

### LIST OF REFERENCES

X1 pumping axis
X2 second axis
X3 third axis
A angle
H32 opening height
P36 depth of the debris trap
D30 diameter of the inlet channel
D36 diameter of the debris trap
10 pump
12 body
14 outer face
16 pumping bore
18 compression chamber
20 inlet valve bore
22 inlet chamber
24 valve guiding bore
26 seating face
28 spring seat
30 inlet channel
32 outer opening
34 inner opening
36 debris trap—blind hole—recess
38 lateral face
40 bottom face

1-6. (canceled)

7. A body of a high pressure fuel pump adapted to be arranged in a diesel fuel injection equipment of an internal combustion engine, said body comprising:
an outer face;
a pumping bore extending along a pumping axis and defining in part a compression chamber;
a cylindrical inlet chamber extending in continuation to the pumping bore defining an inlet opening in said compression chamber;
a fuel inlet channel extending along a second axis making an angle with the pumping axis, said fuel inlet channel extending from an inner opening in said cylindrical inlet chamber to an outer end, fuel at low pressure flowing, in use, in said fuel inlet channel; and
a debris trap dug in said outer face and defining a bottom face and a lateral face, the outer end opening in said lateral face;
wherein said debris trap is cylindrical extending from said outer face to said bottom face along a third axis substantially parallel to the pumping axis.

8. A body as claimed in claim 7 wherein the outer end is adjacent to the outer face, the debris trap extending deeper than said outer end, the bottom face defining a blind end that is at a distance from said outer end.

9. A body as claimed in claim 8, wherein a depth of the debris trap is >a coefficient * a diameter of said fuel inlet channel/sin said angle, wherein 1.0<said coefficient.

10. A body as claimed in claim 7, wherein a diameter of the debris trap is bigger than a diameter of the fuel inlet channel.

11. A body as claimed in claim 10, wherein the diameter of the debris trap is >a coefficient * the diameter of the fuel inlet channel where 1.5<the coefficient.

12. A high pressure pump adapted to be arranged in a diesel fuel injection equipment of an internal combustion engine, said high pressure pump having a body comprising:
comprising:
an outer face;
a pumping bore extending along a pumping axis and defining in part a compression chamber;
a cylindrical inlet chamber extending in continuation to the pumping bore defining an inlet opening in said compression chamber;
a fuel inlet channel extending along a second axis making an angle with the pumping axis, said fuel inlet channel extending from an inner opening in said cylindrical inlet chamber to an outer end, fuel at low pressure flowing, in use, in said fuel inlet channel; and
a debris trap dug in said outer face and defining a bottom face and a lateral face, the outer end opening in said lateral face;
wherein said debris trap is cylindrical extending from said outer face to said bottom face along a third axis substantially parallel to the pumping axis.
